(19) United States
(12) Patent Application Publication
(10) Pub. No.: US 2022/0184959 A1
(43) Pub. Date: Jun. 16, 2022

(54) METHOD OF MAINTAINING INKJET PRINTHEAD MENISCUS

(71) Applicant: BALL CORPORATION, Westminster (CO)

(72) Inventor: Michael W. MILLER, Erie (CO)

(21) Appl. No.: 17/603,083

(22) PCT Filed: Apr. 8, 2020
(86) PCT No.: PCT/US2020/027193

§ 371 Date: Oct. 12, 2021

Related U.S. Application Data
(60) Provisional application No. 62/833,273, filed on Apr. 12, 2019.

(51) Int. Cl. B41J 2/165; B41J 3/407

(52) U.S. Cl. CPC B41J 2/16526; B41J 3/40733

(57) ABSTRACT

A container component decorating system has a decorating station (156), a container component handling module (102), a supply of colored inks, and inkjet printheads (124). The decorating station (156) delivers art graphics to container components (14) in a manufacturing queue (22). The inkjet printheads (124) comprise nozzles through which the colored inks are delivered. A flush cycle controller activated a flush cycle of the nozzles to deposit a flush cycle ink pattern (109) on a substrate to restore a meniscus (110) on the nozzles.

### CROSS-REFERENCE TO RELATED APPLICATIONS

N/A

### FEDERALLY SPONSORED RESEARCH OR DEVELOPMENT

N/A

### TECHNICAL FIELD

The invention relates to decorating metallic containers; more particularly, the invention relates to an inkjet printhead used to decorate metallic containers.

### BACKGROUND OF THE INVENTION

Recent developments in metallic beverage container body decorating allow manufacturers to produce consecutively decorated beverage container bodies having unique finished art relative to each other on a single dry offset beverage container body decorator. Prior to these recent developments, consecutively decorated beverage container bodies exhibited identical finished art. Some of these recent developments are disclosed in U.S. Patent Application Publication No. 2015/0174891 A1 corresponding to U.S. application Ser. No. 14/412,585, which is hereby incorporated by reference as if fully set for herein and for a particular purpose of describing the dry rotary offset printing process as it relates to metallic beverage container bodies for two-piece beverage containers.

In a typical dry rotary offset beverage container body decorator, cartridges are supplied with colored ink that is eventually applied onto a cylindrical sidewall of the metal beverage container body. The printing apparatus is provided with an ink cartridge for each color that one wishes to apply onto the metal beverage container body.

The ink cartridges supply ink to printing plates, which have art in relief corresponding to finished art to be printed onto the metal beverage container. This finished art may be a text, a figure, or any type of graphic which one wishes to make on a metal beverage container. Thus, it is very important to position the printing plate correctly relative to the metal beverage container and the ink cartridges.

It is also important to note that the relief art present on the printing plates is in high relief wherein ink supplied to the art in high relief on the printing plates transfers to a transfer blanket. This transfer blanket is an ink transferring means between the printing plates and the metal beverage container to be printed, generally produced from a rubber, rubber-like, or other pliable material.

The ink-laden relief features on each printing plate come into contact with a single transfer blanket. Thus, each transfer blanket receives ink from a plurality of printing plates to produce a finished artwork design. This is carried out by rotation of a printing plate, which transfers the ink present in relief to the transfer blanket, which is fixed on a transfer blanket drum, which has a rotation synchronized with (i) the metal beverage container bodies to be printed, (ii) the positioning of the transfer blankets that are on the surface of the transfer blanket drum, and (iii) the printing plates.

Each beverage container body engages just one transfer blanket to receive a complete finished art design of multiple colors that the transfer blanket has received from a plurality of printing plates.

A recent development in beverage container body decorating includes providing art in the form of relief features on the transfer blankets. Thus, rather than having a single flat surface that receives ink from the printing plates, each transfer blankets has art in relief, typically low relief engravings or cooperating regions in high and low relief, to produce differing final images on consecutively decorated metallic beverage container bodies on a dry offset rotary beverage container body decorator. This recent improvement allows a manufacturer to decorate beverage containers bodies in a manufacturing queue continuously and without interruption wherein consecutive beverage container bodies are decorated with different images.

However, this prior process limits the manufacturer to a maximum of N different designs on N consecutively decorated beverage container bodies, where N is the number of transfer blankets on a given decorating apparatus. In one example, N is 24. There is a need within the industry to produce an unlimited number of finished art designs on consecutively decorated beverage container bodies within the industry.

Additionally, small-batch beverage producers are becoming increasingly more popular. Unfortunately, due to the economies associated with producing decorated beverage container bodies, small-batch beverage producers can be limited to purchasing unadorned beverage container bodies and will often add a sleeve of some sort to adorn the beverage container bodies with source identifying indicia.

More recently, developers have introduced methods of decorating metallic beverage container bodies using inkjet printhead techniques. One advantage of these methods is that decorators would be free of the limitations of typical dry offset decorators currently used to adorn beverage container bodies. These methods would largely supplant or reduce dependence on the engraved printing plates by using ink jet printheads in combination with printing plates or by replacing printing plates altogether. Thus, this technology would result in decorator apparatuses capable of printing an unlimited number of different designs on consecutively decorated container bodies on a single decorator apparatus. In other words, by way of an example, a decorator outfitted with eight transfer blankets would go from having the capability of printing 8 different finished designs on eight consecutively decorated container bodies to an unlimited number of finished designs on an unlimited number of decorated container body in a queue of consecutively decorated container bodies.

There are problems associated with this new technology. For example, inkjet printhead nozzles need to jet ink at some minimum interval to maintain meniscus stability. A meniscus is a curve in an upper surface of a liquid close to the surface of a container, dispenser, or other object caused by a surface tension of the liquid. In many inkjet applications, meniscus stability is maintained by printing a solid bar of ink at some predetermined interval. However, this method cannot be employed within an indexed container body printer/decorator without impacting the customer's graphic.

This prior practice involves stopping the printer for maintenance more often. At a minimum, the print job may need to be paused while a diagnostic print is run and manually removed.

The present invention is provided to solve the problems discussed above and other problems, and to provide advantages and aspects not provided by prior decorators/printers of this type. A full discussion of the features and advantages of the present invention is deferred to the following detailed description, which proceeds with reference to the accompanying drawings.

### SUMMARY OF THE INVENTION

An aspect of the invention is directed to the development and control of a flush cycle to reestablish and/or maintain a meniscus on a nozzle of an inkjet printhead in a container component decorating system. To develop this aspect of the invention, several further aspects are contemplated which implement and exploit features and functionalities in a container decorating system.

One further aspect is directed to a container component decorating system. This decorating system comprises a decorating station and a flush cycle controller. The decorating station delivers one or more art graphics to a plurality of container components in a manufacturing queue and comprises a container component handling module which delivers container components to a printing site, a supply of ink comprising one or more colored inks, and one or more inkjet printheads which comprise one or more nozzles through which the one or more colored inks are delivered. The flush cycle controller activates a flush cycle of the one or more nozzles to deposit a flush cycle ink pattern on a substrate to restore a meniscus of the one or more nozzles.

The following further aspects may be included, alone or in any reasonable combination. The container component decorating system may further comprise an ink detection sensor which collects ink data associated with the one or more colored inks delivered by the one or more nozzles. The container component decorating system may further comprise a first controller, the first controller evaluating the ink data and providing an alert to initiate the flush cycle. The container component decorating system may further comprise an inspection station downstream in a container manufacturing process from the decorating station wherein the inspection station comprises the ink detection sensor. The inspection station may be in communication with the first controller wherein an evaluation of the one or more art graphics determines whether the flush cycle controller is activated. The container component decorating system may further comprise an ink transfer medium wherein the one or more inkjet printheads deliver the one or more colored inks to the transfer medium, and the ink transfer medium engages the container components to deliver an art graphic to the container components. The container component decorating system may further comprise a sacrificial container component which acts as the substrate and receives the flush cycle ink pattern. The container component decorating system may further comprise an ejection path wherein the sacrificial container component is removed from the manufacturing queue via the ejection path. The container component decorating system may further comprise an ink transfer medium which receives the one or more art graphics from the one or more inkjet printheads and delivers the one or more art graphics to the plurality of container components via engagement with each of the plurality of container components in the manufacturing queue. The ink transfer medium may be a belt comprising an ink receiving surface wherein the flush cycle ink pattern is delivered to the ink receiving surface. The flush cycle ink pattern may bypass engagement with each of the plurality of container components in the manufacturing queue. The belt may comprise a plurality of blanket segments arranged along a surface of the belt, wherein the one or more art graphics are deposited on the plurality of blanket segments, wherein adjacent blanket segments are separated by gaps, and wherein the flush cycle ink pattern is deposited within one or more of the gaps. The flush cycle may be activated upon a predetermined passage of time. The flush cycle may be activated by an operator intervention. The flush cycle may be activated upon the decorator station decorating a predetermined number of container components in the manufacturing queue. The flush cycle may be activated based on ambient atmospheric conditions. A flush cycle interval may be based on a volume of the one or more inks required to print an art graphic in the one or more art graphics. A flush cycle interval may be based on a volume of the one or more inks required to print the one or more art graphics. A flush cycle interval may be fixed by a software routine.

One aspect is directed to a method of maintaining a meniscus on a printhead nozzle of a beverage container component decorating apparatus. The method comprises the steps of: (1) selecting at least one container component in a manufacturing queue comprising a decorating run of a plurality of substantially identical container components; (2) delivering a flush cycle ink pattern to the at least one container component to produce a sacrificial container component during the decorating run; and (3) segregating the sacrificial container component from a remaining group of the plurality of substantially similar container components.

This method may include one more of the following steps, alone or in any combination. The method may include the step of determining a flush cycle interval, the flush cycle interval being a time duration between a first flush cycle and a second flush cycle, each flush cycle depositing a separate flush cycle ink pattern on a separate sacrificial container component. The method may include the step of analyzing an ink pattern on a decorated container component in the decorating run wherein a result of the analysis is used to determine a selection of the at least one sacrificial container component flush cycle. The method may include the step of transferring the flush cycle ink pattern to an ink transfer medium which engages the at least one sacrificial container component to transfer the flush cycle ink pattern to the sacrificial container component. The method may include the step of manually activating a flush cycle which causes the flush cycle ink pattern to be deposited on the at least one container component.

One aspect is directed to a sacrificial container component. Here, a manufacturing queue comprises a plurality of substantially similar container components in a decorating run. Each substantially similar container component receives an ink pattern during the decorating run. The manufacturing queue further comprises at least one sacrificial container component comprising a flush cycle ink pattern.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a schematic of a manufacturing process for producing container components featuring a plurality of upstream and downstream processes in relation to a decorating station;

FIG. 2 is a side view of a decorating apparatus;

FIG. 3 is a close up view of a printing site of a decorating apparatus;

FIG. 4 is a view of a substrate having a flush cycle ink pattern deposited on a surface thereof;

FIG. 5 is a top view of a transfer medium with a flush cycle ink pattern deposited within gaps on an upper surface thereof;

FIG. 6 is a side view of a sacrificial container component with a flush cycle ink pattern deposited on a side wall thereof;

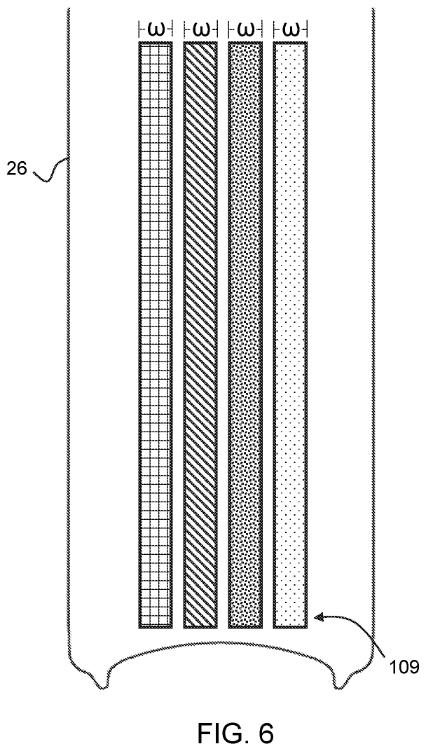

FIG. 7 is perspective of an inspection station; and

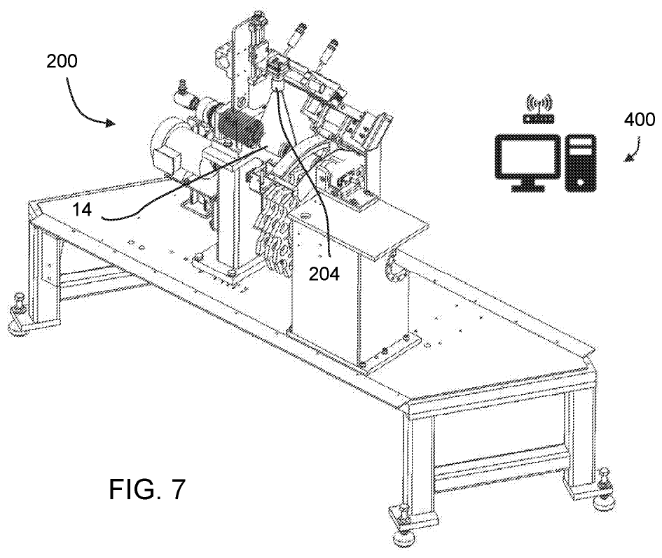

FIG. 8 is an ejection module showing an ejection chute and a sacrificial container component processing therethrough.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

A feature of this disclosure intentionally sacrifices one or more container bodies periodically at predetermined or random intervals to fully “flush” inkjet printhead nozzles. This feature includes the capability of automatically removing sacrificed container components from a production queue of container components. A benefit of the ability to eject these sacrificed container components from the process line is that production does not need to be stopped to maintain printhead nozzle stability.

This technology yields additional benefits. For example, the interval of sacrificed container components can be adjusted by a user as needed to maintain print quality. Alternatively, the interval can be adjusted programmatically via algorithm based on ambient temperature/humidity conditions, or programmatically based on the ink coverage of the customer print (if the ink coverage is low, sacrificial container bodies would be needed more often).

Embodiments of the present disclosure may be distinguished by a flushing interval. A flushing interval is a period between flushing cycles where a flushing ink pattern is deposited on a sacrificial container component. The period can be defined manually by operator intervention of automatically by time duration, a quantity or number of decorated or processed container components, ambient conditions, inkjet printhead use or a combination of these variables. The interval can be fixed in software routine. The interval can be variable and/or dependent upon one more operating conditions, such as ambient temperature/humidity (hotter/drier conditions require more flushing). The flushing interval may be adjusted (perhaps programmatically) based on the ink coverage of the customer job (lower ink output requires more flushing). Flushing may also be triggered on-demand by a vision-inspection camera system downstream in the manufacturing process from the decorator.

A procedure may be performed without operator involvement. In conjunction with an inspection system, for example, as described in PCT/US2017/033527, which is hereby incorporated by reference in its entirety as if fully set forth herein and particularly for the broad aspect of a decorator inspection system incorporated into the container body manufacturing process, the system as defined herein and the visual decoration inspection system are in communication via transmitted signals, wherein the vision system can communicate to a printer/decorator to command the printer/decorator to print one or more sacrificial container components once print quality is detected to be in a degraded state or out of manufacturing tolerance.

An advantage of the present disclosure is improved efficiency by decreasing downtime, in a decorating system as described, a printhead cleaning must be performed every 60-90 minutes. Six printhead cleanings per 8-hour shift (6×15 minutes) could be 90 minutes of downtime, or the potential loss of (90×140 CPM) 12,600 container components. Even if a container component is sacrificed every single minute of an 8 hour production cycle (a rate which should not be required with UV Inks, but could be required with water-based inks), only 480 container components per 8-hour shift would be sacrificed.

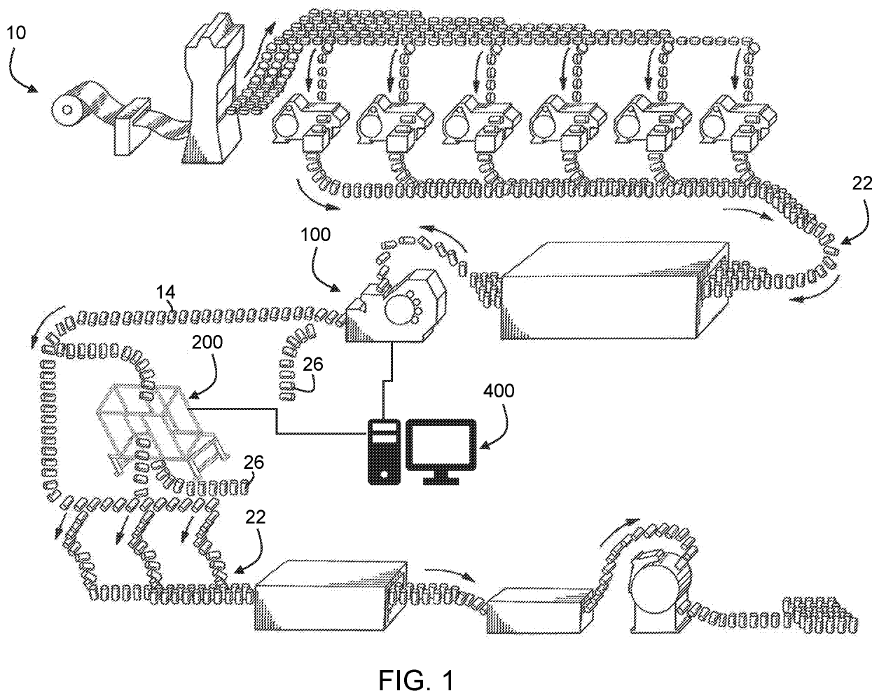

Referring to FIG. 1, a container decorating system may be a subsystem within a container component manufacturing process 10. A schematic of a typical process 10 for producing container bodies 14 is illustrated. However, the systems and subsystems described herein can be readily applied to the production of other container components, such as lids, tabs, etc.

### A Decorating Station

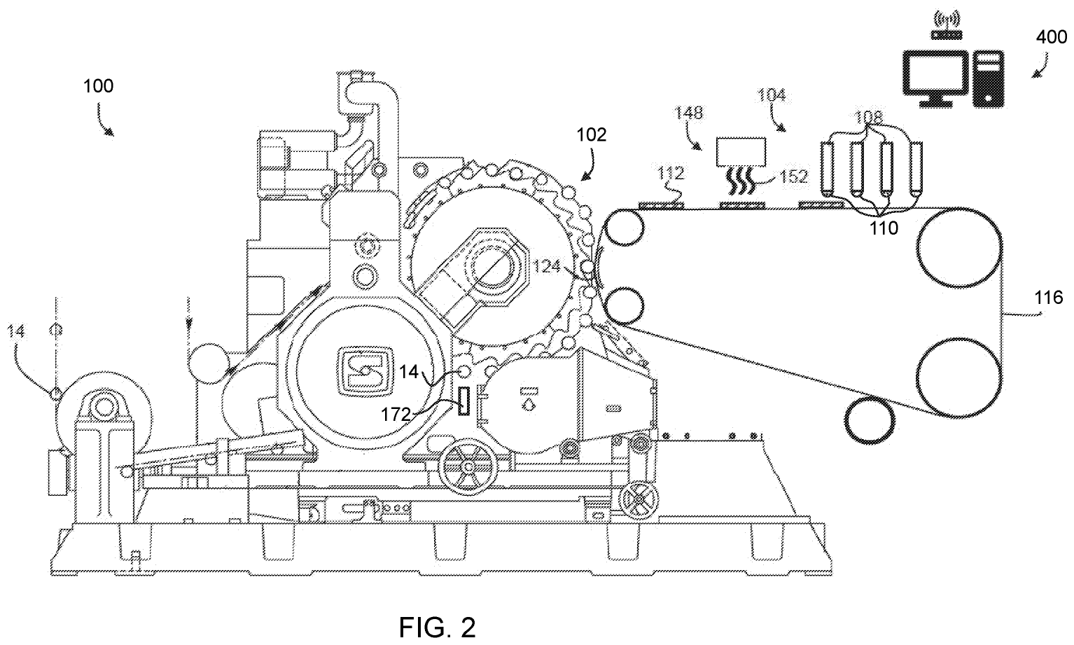

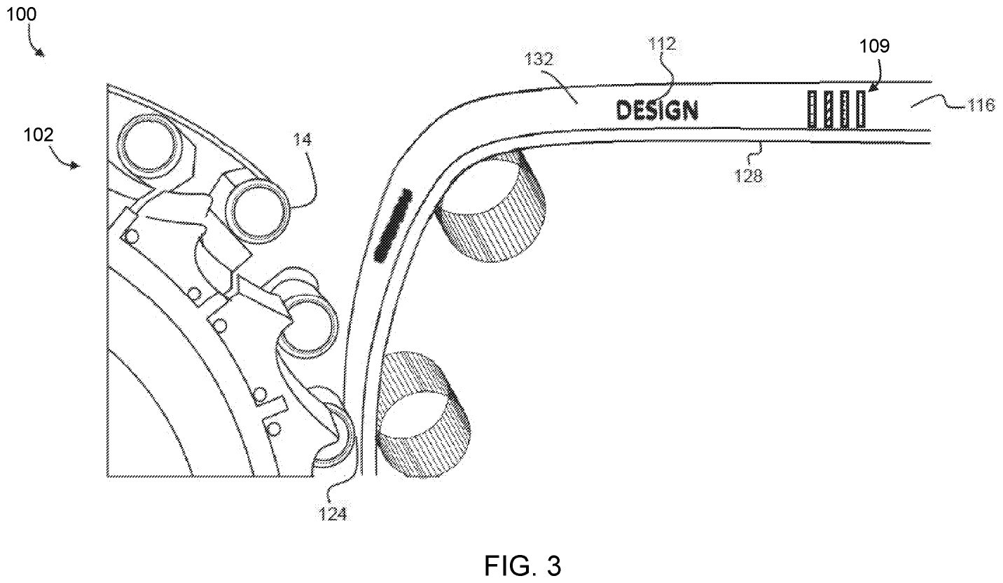

Referring to FIGS. 2 and 3, a decorating station preferably comprises a decorating apparatus 100 which delivers one or more art graphics to a plurality of container components 14 in a manufacturing queue 22. The decorating apparatus 100 has a container component handling module 102 which delivers container components 14 to a printing site 124, a supply of ink in an inker unit 104 comprising one or more colored inks, and one or more inkjet printheads 108 which have one or more nozzles through which the one or more colored inks are delivered. A flush cycle controller which may be housed on a computer 400 activates a flush cycle of the one or more nozzles to deposit a flush cycle ink pattern 109 on a substrate 25 to restore a meniscus 110 of the one or more nozzles. The flush cycle controller can be included in the decorating station or part of a computer network as described below. Thus, the flush cycle controller maybe external or internal to the decorator, for example within a hardware of the decorator itself without any need for an external controller. In other words, as used herein, flush cycle controller is not necessarily an external element and should not be considered as such unless specifically so descriptively modified.

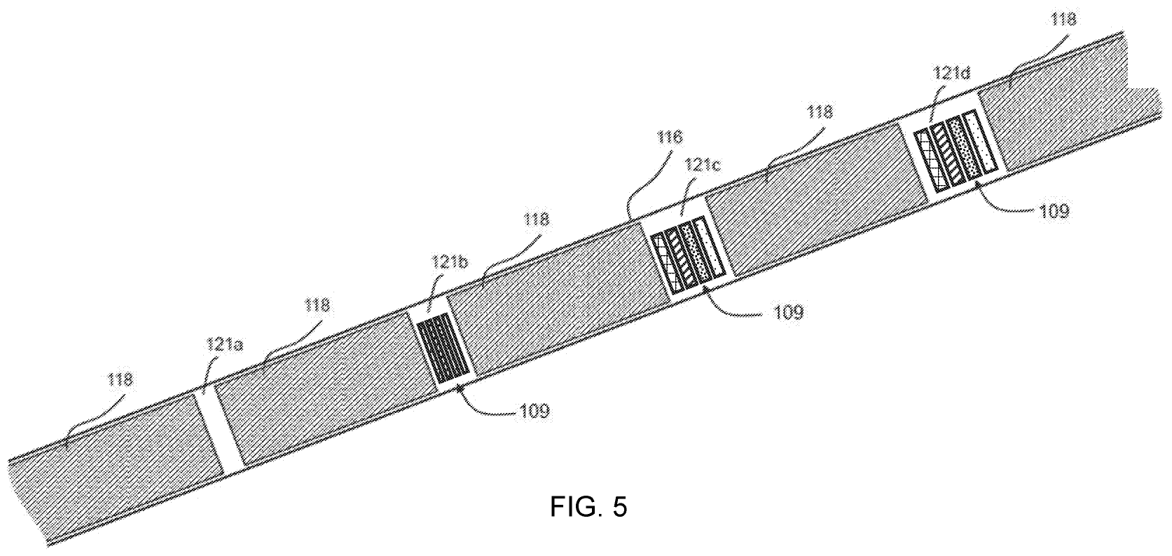

The container component handling module 102 features an indexer which transports container components 14 one-by-one to the printing site 124 where ink is transferred from an image transfer medium, such as a continuous belt 116 as illustrated in FIG. 2, a segmented transfer blanket as illustrated in FIG. 5, or any of the more traditional offset type transfer systems known in the art which generally employ a plurality of transfer blankets attached to a rotation transfer drum. In any case, the decorating apparatus 100 comprises an inkjet printhead 108.

The decorating apparatus 100 has an inker unit 104 comprising a plurality of printheads 108. The inkjet printheads 108 deliver a volume of ink 112 via the nozzles in a desired pattern to the image transfer belt 116. Each printhead 108 delivers a quantity of ink 112 to the transfer medium to produce a desired pattern of ink 112 in a desired color, preferably multiple colors.

The image transfer medium transports a pattern of ink 112 received from the inkjet printheads 108 to a printing site 124 where engagement (i.e. contact) between the container component 14 and the image transfer medium transfers the ink 112 to impart the art graphic directly on the container component 14.

The ink 112 pattern is transferred to the container component 14 by compressive force on the beverage container component and the image transfer belt 116. More specifically, a printing surface 132 carrying the desired pattern of ink 112 is forced against one of the plurality of container components 14 supported by an impression member as the container component 14 rotates about a center axis of the impression member.

The decorating apparatus 100 may be outfitted with an ink curing station 148. This ink curing station 148 may comprise a source of heat 152. The heat 152 pre-cures the ink 112 on the image transfer medium to minimize wet on container component 14 issues. This creates a more stable ink 112 as an ink image or pattern prior to transferring the ink 112 to the container component 14. Due to printing to the transfer medium and pre-curing, multiple color dots can be combined to generate a larger color pantone options with base colors.

The decorating apparatus 100 allows a one-touch application of an entire art graphic. Continuous application of ink 112 onto the transfer medium allows for the limiting speed factor of the printhead 108 to be maximized. Printhead 108 jetting onto a receptive transfer medium in a repeatable position/condition medium as opposed to a moving round container component with a variable surface leads to consistency and speed.

It is further contemplated that the decorating apparatus 100 can be configured to directly deposit an art graphic on a container component 14 without first depositing the ink 112 on a transfer medium.

The decorating apparatus 100 may deposit a flush cycle ink patter 109 into the manufacturing run during a print run of consecutively decorated container components 14. One purpose of the flush cycle ink pattern 109 is to jet a substantial volume of ink 112 (compared to the ink jetted during a typical print). By jetting a predetermined volume of ink 112 in a short time interval, each inkjet printhead 108 nozzle becomes sufficiently “flushed” and an ink meniscus is reformed. This meniscus 110 is critical to the performance of inkjet printheads 108.

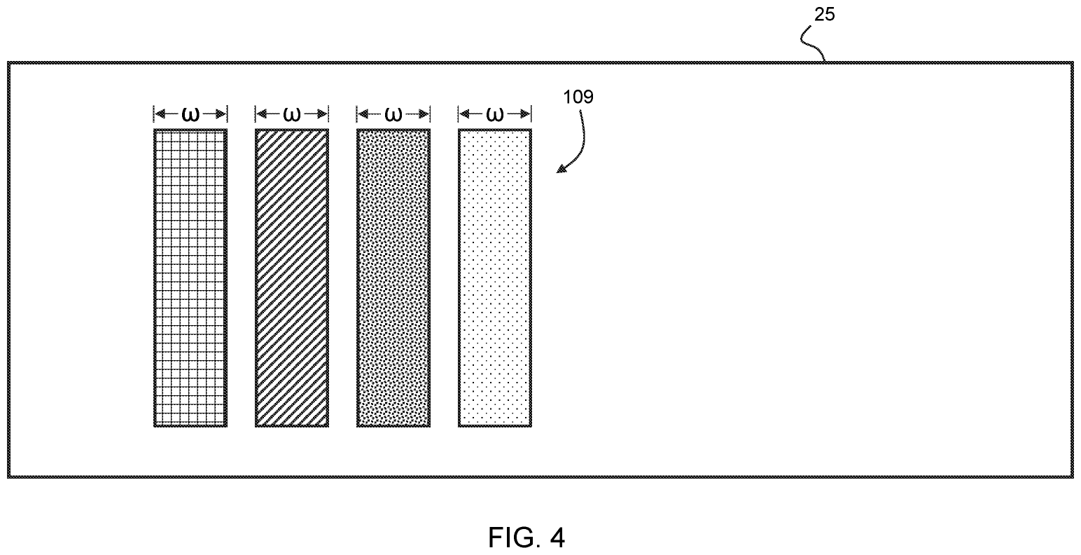

As an example, the flush cycle may deposit a flush cycle ink pattern 109 where 0.5 inches of ink 112 of each color is jetted at 100% density. For example, referring to FIG. 4, the 0.5 inches is an indication of a width w of the rectangle or bar of the flush cycle ink pattern 109 on a given substrate. This measurement also refers to a time variable, i.e. a cycle. Functionally, the flush cycle relates to an amount of ink 0.5 inches of printing, in a typical case might be 2 mL per color. One hundred percent density jetting refers to the printhead jetting the largest drops it can (varies by printhead model) over whatever time duration or interval an operator or designer asks/requests/demands/pre-programs. Basically, in the illustrated embodiments, solid rectangles/bars are printed with using as much ink as the apparatus, including, primarily, the printheads, is capable of depositing on a substrate (i.e. a transfer medium, a target to be printed, can component, etc.). “Each color” as used herein refers to the exact color of ink contained within each printhead 108. This is typically cyan, magenta, yellow, and key (typically black) (“CMYK”); however, “each color” may also include other colors, such as orange and green, for extended gamut printing, or even a specific spot color.

This flush cycle is necessary because under typical use, an inkjet-type decorating apparatus 100 may not utilize all the nozzles of each color. For example, if an upper half of a finished container art graphic does not employ black ink, then the black printhead nozzles in that area would not jet any ink. Given that one aspect of digital decoration is to print variable data (i.e. different art graphics in a single manufacturing run), if a container component 14 art graphic comes along later in the manufacturing queue 22 or print run which requires black ink in that area, the black inkjet nozzles might have a dried or broken meniscus 110 by the time a container component 14 requiring the design arrives at a printing site. Thus, when that container component 14 arrives at the printing site 124, and it is finally time to print, the print quality would not be acceptable or out of the customer's specification or the manufacturing tolerance.

Thus, the number of nozzles employed during any one manufacturing run or print run can vary, depending on the art graphics delivered during the run. In some manufacturing runs, one or more of the nozzles may be used less than the others or not at all. To retain their ability to function, these nozzles must jet ink at some minimum interval to maintain meniscus 110 stability. In most applications, this is done by printing a flush cycle ink pattern 109, typically solid bar(s) 500 of ink at some point. This flush cycle ink pattern 109 printing cannot be done within an indexed container printer without impacting an art graphic deposited on the container component 14.

Accordingly, a feature of the present disclosure periodically (predetermined, randomly, and/or upon receipt of an alert) and intentionally sacrifices one or more container components 14, as needed, to “flush” the printhead nozzles fully. This feature may include removing or ejecting sacrificial container components 26 from the manufacturing queue 22. Thus, production and decoration of container components 14 does not need to be stopped in order to maintain printhead nozzle stability.

Many approaches can be taken to controlling flush cycle intervals (i.e. a time period between flush cycles). The flush cycle interval can be adjusted or controlled manually by an operator intervention as needed to maintain print quality, adjusted programmatically, e.g. by software subroutine, based on inspection evaluation an of art graphics produced during the manufacturing run, based measurements of atmospheric or ambient conditions, such as temperature, humidity, dew point, pressure, etc., and/or predetermined based on the ink coverage of the customer's desired art graphic print. If the ink coverage needed to create the art graphic is low, sacrificial container components 26 would be needed more often. Generally, flush cycle intervals vary by printhead and ink type.

In one embodiment, a flush cycle, wherein a volume of ink 112 must be jetted from a given printhead 108 every 30 seconds to avoid a meniscus break. A meniscus 110 can usually be recovered within as few as three jetting operations in a fraction of a second.

Where several minutes, e.g. greater than 10, elapse without a printhead 108 jetting a volume of ink 112, a printhead nozzle meniscus 110 can break and also dry while open. This may require physical cleaning before the printhead 108 will jet again. Addressing this case by avoiding its occurrence is just one object of this disclosure.

By way of illustrative example, if a print or decorating run, requires printing solid red container components for a substantial period of time, e.g. an hour, it is unlikely that printheads 108 delivering black or cyan ink would be used much, if at all. Those printheads 108 are likely to be completely dried out and require hand-cleaning before a decorating run requiring the decorating apparatus to print blue container components may begin. This disclosure addresses that situation by requiring a flush cycle and the production of a sacrificial container component 26.

Particular to the present disclosure, the decorating system utilizes one or more substrates 25, e.g. sacrificial container components 26, in order to print a flush cycle ink pattern 109 by one or more of the printheads 108. The flush cycle ink pattern 109 is designed to be dynamically recognized by an ink detection sensor 172 which collects or recognizes ink data associated with the one or more colored inks delivered by the one or more nozzles. This can be accomplished by the ink detection sensor 172 being configured to recognize a dark/light/dark/light/dark/light/dark flush cycle ink pattern 109 as illustrated in the figures. The ink detection sensor 172 can be an element of the decorating station (as shown in FIG. 2) or in a separate inspection station as described below. It is further contemplated that the eject function can be electronically integrated such that a controller and/or computer 400 can directly signal the ejection of the sacrificial container 26 without detection of the flush cycle ink pattern 109 by tracking the sacrificial container 26 in the process.

The system is responsive to the ink data collected or recognized by the ink detection sensor 172. In the case where the ink detection sensor 172 detects a flushing cycle ink pattern 109, the substrate 25, in this case typically a sacrificial container component 26, can be ejected from the manufacturing queue 22. In this manner, the intended design of the normally printed container components 14 does not need to take into account the needs of printhead meniscus 110 stability in that design. In one embodiment, ejection of one or more sacrificial container components takes place on a track work.

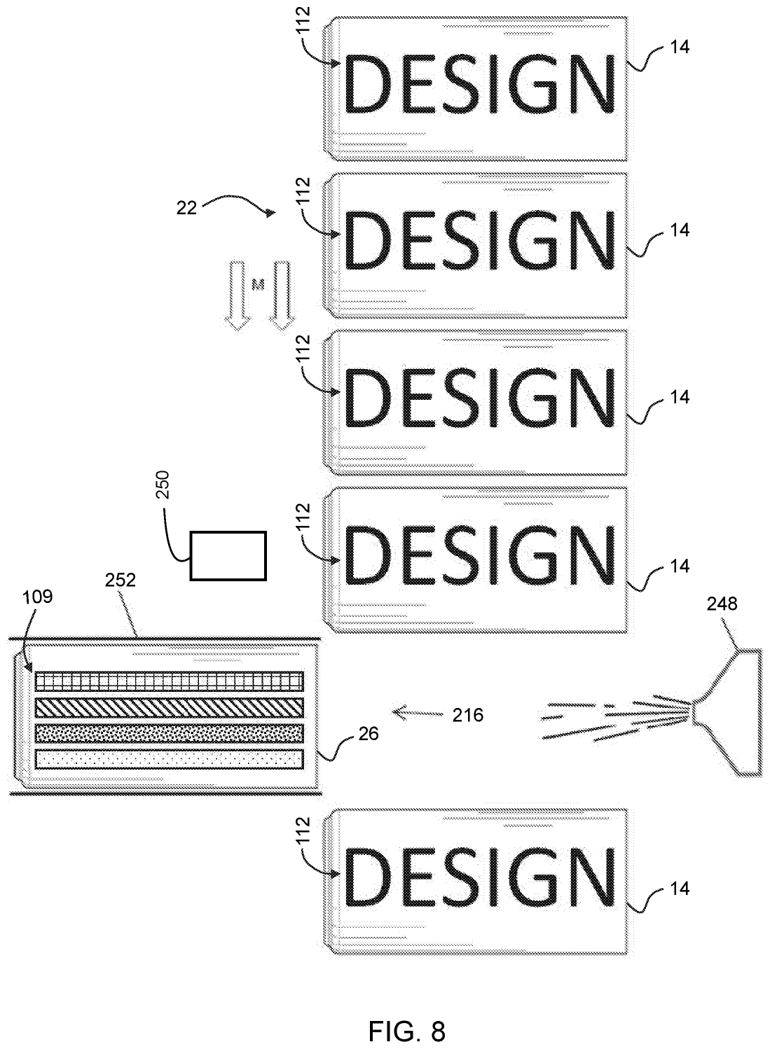

The decorating station may have an ejection system as shown in FIG. 8. A container component ejection sensor ensures that a container component having a flush cycle ink pattern 109 is ejected. An air knife may be provided to blow the container component 26 into an eject chute 252. A control system flags a sacrificial container component 26 as it passes by the ink detection sensor 172. The sacrificial container component 26 is tracked until it reaches the ejection chute 252 at an ejection position 216. When it senses that the sacrificial container component 26 is passing the eject chute, the air knife 248 blows the sacrificial container component 26 into the eject chute 252.

It is contemplated that the ink 112 of the flushing cycle ink may be deposited on a substrate 25 other than a sacrificial container component 26. For example, referring to FIGS. 1, 2, and 5, a decorating apparatus 100 may be outfitted with a transfer belt 116, such as a non-segmented or segmented transfer belt 116 as illustrated. These belts 116 are fully described in PCT/US2018/051717 and PCT/US2018/051719, which are hereby incorporated by reference as if fully set forth herein and for the particular purpose of describing the particular transfer belts 116 described therein.

Referring specifically to FIG. 5. a segmented image transfer blanket 116 has a plurality of adjacent blanket segments 118 separated by gaps 121a-d. The gaps 121a-d may be a recessed surface of the segmented image transfer blanket 116, at least relative to printing surfaces on the blanket segments 118. Each blanket segment 118 has a printing surface configured to accept the volume of ink 112 from the ink-jet printing heads 108 and transfer the ink 112 to the container components. Thus, a segmented image transfer blanket 116 may have a gap 121a-d between adjacent blanket segments 118 which has a surface height that is recessed in relation to the printing surfaces of the adjacent blanket segments 118.

In the case of such a segmented belt 116, the ink 112 of the flush cycle ink pattern 109 can be deposited between the blanket segments 118 within one or more of the gaps 121a-d.

Alternatively, a very thin plate can be configured to swing or be transferred into a position beneath the inkjet print heads 108 to deflect or “catch” ink droplets or the flush cycle ink pattern as they/it are/is jetted onto the plate. Another alternative employs a fluid pressure. Here, a source of a fluid pressure blows a gas, for example air, physically blows the ink droplets or ink for a flushing pattern delivered by the inkjet printheads 108 to the side via an air knife wherein the ink is not deposited onto a container component. While these alternatives have advantages, neither of these alternatives enjoys, at least, the cost and logistical advantages of printing a sacrificial container component with the flush cycle in pattern.

### An Inspection Station

The present system may incorporate an inspection station 200 such as those described in PCT/US2017/033527, which is hereby incorporated by reference as if fully set forth herein. Particular to the present disclosure, the inspection station 200 can be used to control, determine, activate, etc. the flushing cycle and or flushing cycle interval, the sacrificial container component(s) 26 and the flushing cycle ink pattern 109.

The inspection station 200 is generally downstream in a container component manufacturing process 10 from the decorating station 100. In terms of process steps, the inspection station 200 is located after the decorating station 100 and optionally post-decoration oven station. Thus, in one example, the container component 14 may be a container body which has a cylindrical sidewall separating an open end from an integral closed end wherein a portion of the sidewall immediately adjacent the open end has a circumference that is substantially equal to the circumference of a portion of the sidewall adjacent the integral bottom portion.

It is contemplated that the inspection station 200 will be installed as close to the end of the decorating station 100 as possible, to minimize bad (i.e. defective, sub-standard, non-conforming) beverage container component production. By locating the inspection closer to the decorator, fewer “bad components” are produced prior to discovering and resolving the cause of the defects. This station 200 is primarily looking for decoration defects.

The inspection station 200 includes an ink detection sensor 204. The ink detection sensor can be an optical sensor, e.g. a camera or any other known and unknown techniques, including but not limited to UV and/or infrared inspection as well as other non-optical related measurements such as surface energy.

For the present disclosure, the purpose of the inspection station 200 is to identify when a flushing cycle of the printhead nozzles is necessary. This can be accomplished by identifying characteristics of ink deposited on one or more container components that are associated with meniscus instability. There are two main categories of meniscus failure.

A first is jetout. This occurs when printhead nozzle is not jetting ink at all due to a completely broken meniscus. This commonly presents itself as a very narrow stripe of missing color in the finished design, i.e. a decorated container component.

A second category is deviation. Deviation occurs when a printhead nozzle is jetting ink, but not directly downward. Here, the ink drops typically jet at an angle and may contain less or more ink than they should. This is typically caused by a partially formed meniscus or partially blocked nozzle. Deviation is the more difficult of the two categories to detect, it generally presents itself as a dark stripe on the finished design.

Both these situations are best addressed by flooding a nozzle with ink during a flush cycle with the intent of clearing any blockage and reforming the meniscus. The sooner this operation can be done after the failure is identified, the better. This is a primary driver behind the present disclosure, i.e. providing a capability to perform one or more flushing cycles without stopping the manufacturing process or waiting for a maintenance window (an open time period in which maintenance can be performed on the manufacturing/decorating apparatus).

In one embodiment, ejection of one or more sacrificial container components takes place on a track work. A container component ejection sensor 250 ensures that a container component 14 having a flush cycle ink pattern 109 is ejected. An air knife 248 may be provided to blow the container component 26 into a eject chute 252. A control system flags a sacrificial container component 26 as it passes by the ink detection sensor 204. The sacrificial container component 26 is tracked until it reaches the ejection chute 252 at an ejection position 216. When it senses that the sacrificial container component 26 is passing the eject chute 252, the air knife 248 blows the sacrificial container component 14 into the eject chute 252. (See FIG. 8).

It should be understood that the inspection station 200 is fully programmable. Furthermore, a controller is capable of synchronizing the movement of an inspection station container component handling module with the overall manufacturing process. It generally follows that a programmable controller which may be housed on a computer 400 and can be used to control the timing of the inspection station 200. The computer 400 may have a software routine store on a memory wherein the software routine controls movement of the inspection station and the decorating station. The computer 400 can also be used to determine the attributes of the flush cycle, including flush cycle interval, extent and identity of the nozzles flushed, volume of ink flushed, the shape, size, location, etc. flush cycle ink pattern.

It should be clearly understood that the colors or the printhead nozzles to flush can be individually chosen programmatically. While there is no true detriment to extra flushing, such extraneous flushing unnecessarily expends ink with each flush. By way of an illustrative example, if magenta is the only misbehaving or malfunctioning color, one would only want to flush magenta in order to not waste the other inks. This behavior would be configurable via a software routine stored on the computer 400.

As shown, the inspection station 200 may be outfitted with an ejection system. The ejection system includes an ejector positioned between an index path and the manufacturing queue 22 for culling the sacrificial container component 26 from the manufacturing stream of sequentially processed container components prior to transferring the container component to a subsequent process. The ejector may be a mechanical spring-loaded kick-out, a mechanical arm, pendulum, plunger, piston, plate, or grasping apparatus, or other mechanical system, but is preferably a blow-off nozzle, such as an air knife 248, including a source of fluid pressure in which activation of same is either manually controlled or, more preferably controlled by a signal originating from a software routine stored in the memory on a computer 400 which compares the results of an evaluation corresponding to the ink data collected by the ink detection sensor to a quality standard preset by the manufacturer. If, upon comparison of the inspected container component 14 to the quality standard, the container component 14 is deemed to fail the quality standard, the fluid pressure is activated and delivered through the blow-off nozzle to the container component which thrusts the container component from the indexer to a reject chute and into a waste area, such as waste bin. This same evaluation can be used to initiate one or more flush cycles at the decorating station.

The ejector is located between an index path of the inspection station 200 and the manufacturing queue 22. That is, the ejector is capable of removing a defective container component or sacrificial container component 26 prior to subsequent steps in the manufacturing process 100.

### A Computer

A computer or computers 400 may be included in the system. For purposes of this description, one or more computers are referred to in the singular, but it should be understood that the decorating station and the inspection station 200 may have computers devoted solely to the individual process, and these computers can function as single network wherein signals generated and received by and between the processes can be used to effect changes in the processes or to trigger certain processes or subroutines. In one particular example, the computer can be used to control a flushing cycle of one or more inkjet printheads 108 on the decorating apparatus 100. Thus, it follows that a computer 400 has a software stored in a memory.

One computer 400 has a software associated with the inspection station 200. The software controls the evaluation of the quality of the art graphics and flush cycle ink pattern 109 by comparing ink data of an actual pattern of ink against a quality standard, such as a customer specification or manufacturing tolerance. For the purposes of this disclosure, the software compares colors and printed patterns to determine when a flushing cycle is necessary and which printhead nozzles must be flushed and to what extent. When an ink-related anomaly is detected, either a signal is sent directly to, or generated within, the decorating station to cause one or more flush cycles using a software or a signal is sent to an operator to manually cause the necessary flush cycle(s).

In an embodiment, a software on the computer 400 may be used to detect color hue on the container components 14, for example wavelength, saturation also called “chroma”, and brightness also called “luminance” or “value,” which is the shade (darkness) or tint (lightness) of a color. This software can also close the loop and be used to automatically adjust the decorating station to obtain the correct hue. The software would inspect the container components after decoration via optical scanner and look for representative signs of meniscus instability. If such instability is found, the software would be able to trigger the flushing process for the affected color plane(s)

### ILLUSTRATIVE EXAMPLES

Methods of the present disclosure trade a small amount of input material (container components) to maintain the health of the most critical asset to a digital decoration system, the decorating apparatus. The number of sacrificed container components is customizable by an operator, but a reasonable expected trade-off is sacrificing 1 container component every ˜5 minutes in order to extend the printhead cleaning interval by 2-8 hours. This takes an offline cleaning procedure, with an estimated time of 10-30 minutes, and replaces it with an online flushing procedure which sacrifices a single container component every 5 minutes.

In one embodiment, container component inspection is performed manually by an operator visually in-hand, this allows the inspection to be performed under a minimal time duration which prevents container components being produced with art graphics that are outside the manufacturing tolerance for same. In an embodiment where inspection is performed automatically by an ink detection sensor 172,204, the method removes the sacrificial container component 26 from the manufacturing queue 22 before additional manufacturing processes are wastefully performed on the sacrificial container component 26.

In one embodiment, an ink detection sensor 172,204 can be used and directed at a specific portion of the container component 14 to detect print and/or color quality. An ink detection sensor 172 can be included on the decorating station 100. An ink detection sensor 172,204 can send a signal to the computer 400 where an evaluation of the collected ink data is performed to determine whether a flushing cycle is necessary.

In one embodiment, a sacrificial container component 26 is removed from the manufacturing queue 22 immediately, or substantially immediately, after the decorating of the container component with a flush cycle ink pattern 109.

In one embodiment, a printed flush cycle ink pattern 109 is adapted, as in shaped and located, to be recognized by an ink detection sensor 172,204, such as an optical sensor.

In one embodiment, any or all of the sensors 172,204,250 are optical sensors.

In one embodiment, any or all of the sensors 172,204,250 are light sensors.

In one embodiment, any or all of the sensors 172,204,250 are energy sensors.

In one embodiment, a sacrificial container component 14 is recognized by the ink detection sensor 172,204 and removed from the manufacturing queue 22 automatically.

In one embodiment, the decorating station 100 is in communication with a downstream device which ejects a sacrificial container component 26 from the manufacturing queue 22. It is important for the sacrificial container component 26 to be removed from manufacturing queue 26. Otherwise, the sacrificial container component 26 could be finally palletized with a customer's container component order.

In one embodiment, an inspection station 200 performs an evaluation of all of the colors on a decorated beverage container component 14 and a software on the computer 400 quantitatively and/or qualitatively analyzes the colors on the container components 14 and automatically adjusts the decorating station to order a flush cycle. For example, a camera and software may determine that the color red is light 3%, and automatically adjust the decorating station.

In one embodiment, the flushing interval is determined as a function of results from a visual or optical inspection. For example, an inspection result indicates that nozzle flushing is necessary. The flush cycle interval can be varied such that several consecutive container components in a manufacturing queue 22 become sacrificial container components 26 by receiving one or more flush cycle ink patterns 109.

While the specific embodiments have been illustrated and described, numerous modifications come to mind without significantly departing from the spirit of the invention, and the scope of protection is only limited by the scope of the accompanying Claims.

1.-26. (canceled)

27. A container component decorating system comprising:
a decorating station (156), the decorating station (156) comprising a decorating apparatus (100), the decorating apparatus (100) delivering one or more art graphics to a plurality of container components (14) in a manufacturing queue (22), the decorating apparatus (100) comprising:
a container component handling module (102), the container component handling module (102) delivering container components (14) to a printing site (124);
a supply of ink comprising one or more colored inks; and
one or more inkjet printheads (108) comprising one or more nozzles through which the one or more colored inks are delivered;
a flush cycle controller, the flush cycle controller activating a flush cycle of the one or more nozzles to deposit a flush cycle ink pattern (109) on a substrate to restore a meniscus (110) of the one or more nozzles.

28. The container component decorating system of claim 27 further comprising:
an ink detection sensor (172), the ink detection sensor (172) collecting ink data associated with the one or more colored inks delivered by the one or more nozzles.

29. The container component decorating system of claim 27 further comprising:
a first controller, the first controller evaluating the ink data and providing an alert to initiate the flush cycle.

30. The container component decorating system of claim 28 further comprising:
an inspection station (200) downstream in a container manufacturing process from the decorating station (156) wherein the inspection station (200) comprises the ink detection sensor (172).

31. The container component decorating system of claim 30 wherein the inspection station (200) is in communication with the first controller and wherein an evaluation of the one or more art graphics determines whether the flush cycle controller is activated.

32. The container component decorating system of claim 27 further comprising:
an ink transfer medium wherein the one or more inkjet printheads (108) deliver the one or more colored inks to the transfer medium, and the ink transfer medium engages the container components (14) to deliver an art graphic to the container components (14).

33. The container component decorating system of claim 27 further comprising:
a sacrificial container component (14), the sacrificial container component (26) acting as the substrate and receiving the flush cycle ink pattern (109).

34. The container component decorating system of claim 33 further comprising:
an ejection path wherein the sacrificial container component (26) is removed from the manufacturing queue (22) via the ejection path.

35. The container component decorating system of claim 27 further comprising:
an ink transfer medium, the ink transfer medium receiving the one or more art graphics from the one or more inkjet printheads (108) and delivering the one or more art graphics to the plurality of container components (14) via engagement with each of the plurality of container components (14) in the manufacturing queue (22).

36. The container component decorating system of claim 35 wherein the ink transfer medium is a belt (116) comprising an ink receiving surface wherein the flush cycle ink pattern (109) is delivered to the ink receiving surface.

37. The container component decorating system of claim 36 wherein flush cycle ink pattern (109) bypasses engagement with each of the plurality of container components (14) in the manufacturing queue (22).

38. The container component decorating system of claim 37 wherein the belt (116) comprises a plurality of blanket segments (118) arranged along a surface of the belt (116), wherein the one or more art graphics are deposited on the plurality of blanket segments (118), wherein adjacent blanket segments (118) are separated by gaps (121a-d), and wherein the flush cycle ink pattern (109) is deposited within one or more of the gaps (121a-d).

39. The container component decorating system of claim 27 wherein the flush cycle is activated by an operator intervention.

40. The container component decorating system of claim 27 wherein the flush cycle is activated upon a predetermined passage of time.

41. The container component decorating system of claim 27 wherein the flush cycle is activated upon the decorator station decorating a predetermined number of container components (14) in the manufacturing queue (22).

42. The container component decorating system of claim 27 wherein the flush cycle is activated based on ambient atmospheric conditions.

43. The container component decorating system of claim 27 wherein a flush cycle interval is based on a volume of the one or more inks required to print an art graphic in the one or more art graphics.

44. The container component decorating system of claim 27 wherein a flush cycle interval is based on a volume of the one or more inks required to print the one or more art graphics.

45. The container component decorating system of claim 27 wherein a flush cycle interval is fixed by a software routine.

46. A method of maintaining a meniscus (110) on a printhead nozzle within the container component decorating system of claim 1 comprising the steps of:
selecting at least one container component (14) in a manufacturing queue (22) comprising a decorating run of a plurality of substantially identical container components (14);
delivering a flush cycle ink pattern (109) to the at least one container component (14) to produce a sacrificial container component (26) during the decorating run; and
segregating the sacrificial container component (26) from a remaining group of the plurality of substantially similar container components (14)

47. A method of maintaining a meniscus (110) on a printhead nozzle of a beverage container component decorating apparatus comprising the steps of:
selecting at least one container component (14) in a manufacturing queue (22) comprising a decorating run of a plurality of substantially identical container components (14);
delivering a flush cycle ink pattern (109) to the at least one container component (14) to produce a sacrificial container component (26) during the decorating run; and
segregating the sacrificial container component (26) from a remaining group of the plurality of substantially similar container components (14).

48. The method of claim 47 further comprising the step of determining a flush cycle interval, the flush cycle interval being a time duration between a first flush cycle and a second flush cycle, each flush cycle depositing a separate flush cycle ink pattern (109) on a separate sacrificial container component.

49. The method of claim 47 further comprising the step of analyzing an ink pattern on a decorated container component (14) in the decorating run wherein a result of the analysis is used to determine a selection of the at least one sacrificial container component flush cycle.

50. The method of claim 47 further comprising the step of transferring the flush cycle ink pattern (109) to an ink transfer medium which engages the at least one sacrificial container component (26) to transfer the flush cycle ink pattern (109) to the sacrificial container component (26).

51. The method of claim 47 further comprising the step of manually activating a flush cycle which causes the flush cycle ink pattern (109) to be deposited on the at least one container component (14).
